(19) United States
(12) Patent Application Publication
(10) Pub. No.: US 2011/0000878 A1
(43) Pub. Date: Jan. 6, 2011

(54) INK JET-PRINTABLE COMPOSITION AND A MASKING PROCESS

(75) Inventors: Alexander Grant, Bath (GB); Samuel Thomas Moncur, North Somerset (GB); Nigel Anthony Caiger, Somerset (GB)

Correspondence Address: DICKSTEIN SHAPIRO, 1633 Broadway, NEW YORK, NY, 10019, US

(73) Assignee: Sun Chemical, B.V.

(21) Appl. No.: 12/920,491

(22) PCT Filed: Mar. 2, 2009
(86) PCT No.: PCT/GB09/00558

§ 371 Date: Sep. 1, 2010

(30) Foreign Application Priority Data
Mar. 26, 2008 (GB) 0805495.9

(51) Int. Cl. H01B 13/16; C08L 83/06; C08F 2/46

(52) U.S. Cl. 216/13; 524/588; 522/172

(57) ABSTRACT

A radiation-curable, ink jet-printable composition comprising a compound having a reactive silyl group that is suitable for use as a masking composition and/or processes in which the composition is applied onto a substrate; the printed composition is exposed to radiation to form a cured image that masks selected areas of the substrate; the unmasked areas of the substrate are modified; and the cured image is treated with an alkaline solution in order to release the cured image from the substrate.

The invention relates to a composition and a process of masking areas of a substrate during modification of the substrate surface. In particular, but not exclusively, this invention concerns an ink jet-printable composition suitable for use as a masking composition and/or processes in which the composition is ink jet printed onto a substrate to mask regions of the substrate whilst unmasked regions of the substrate are modified, the masking composition then subsequently being removed.

### BACKGROUND TO THE INVENTION

In order to function as a mask, a composition should cure to form a film that adheres well to a substrate and is resistant to conditions used to modify unmasked areas of a substrate whilst being easily removable from the substrate once it is no longer required, for example, by washing with a solvent or caustic solution. Most commercially available masking compositions are hot-melt inks that are liquid when applied at high temperatures and subsequently solidify on cooling. The printing of such inks requires expensive and specialised printing equipment. Furthermore, such inks are not suitable for use as a mask in processes involving high temperatures. Radiation-curable jet inks form durable films on many materials including plastics and paper and therefore are used in a range of graphics markets. Radiation-curable inks are also printable using a wide range of print heads. Although it is also known to use such radiation-curable ink jet-printable compositions, and in particular free radically-curable compositions, as masking compositions commercially available ink jet-printable masking composition are typically not cleanly removed from substrates using alkaline solutions once cured. Many commercially available radiation-curable ink jet-printable masking compositions peel off substrates in sheets or large pieces. Furthermore, many conventional masking compositions are not resistant to high temperatures, for example to temperatures of greater than 100° C.

There remains a need for an ink jet-printable composition that forms a film that adheres well to substrates, provides adequate resistance to conditions under which the unmasked areas of a substrate are modified and is cleanly removable from the substrate once its masking function is not longer required. In particular, there is a need for ink jet-printable compositions that form a film that adheres well to substrates and provides adequate resistance to acidic conditions and/or do not degrade at high temperatures.

### DESCRIPTION OF THE INVENTION

The present invention provides a method of modifying the surface of a substrate comprising the steps of:
a) applying a radiation-curable masking composition comprising a compound having a reactive silyl group and which cures to form an alkali removable image, onto the substrate;
b) exposing the printed composition on the substrate to radiation to form a cured image (thereby masking certain areas of the substrate and leaving other areas unmasked);
c) modifying the unmasked areas of the substrate; and
d) treating the cured image with an alkaline solution in order to release the cured image from the substrate.

The invention further provides a radiation-curable, composition suitable for use as a masking composition in the method of the invention.

It has been found that cured compositions comprising a compound having a reactive silyl group that cures under acidic conditions may be cleanly removed from substrates using alkaline solutions. It has been found that compositions of the invention may be formulated that, once cured, are resistant to acid conditions that may be used to etch a substrate and/or high temperatures that may be used in deposition processes (i.e. processes where further material is added to unmasked regions of the substrate). Preferably, the masking composition is an ink-jet printable composition. Preferably, the masking composition is applied to the substrate by an ink jet printing process.

A “reactive silyl group” is a labile groups attached to a silicon atom. Labile groups are any hydrolysable groups and hydrogen. Reactive silyl groups are typically groups including reactive Si—O bonds, such as reactive acyloxysilyl and alkoxysilyl groups. Other examples of reactive silyl groups are groups including reactive Si—Cl bonds. The components having a reactive silyl group may include one or more reactive silyl groups. Preferred compounds having a reactive silyl group include monofunctional silane compounds, difunctional silane compounds and trifunctional silane compounds. Difunctional silanes include two reactive Si—O bonds either on a single silicon atom such as compounds including dialkoxysilane moieties or on two separate silicon atoms. Trifunctional silanes include three reactive Si—O bonds either on a single silicon atom such as compounds including trialkoxysilane moieties or on two or more separate silicon atoms. The compound having a reactive silyl group may have more than three reactive silyl groups, for example, four or six reactive silyl groups. Examples of compounds having more than three reactive silyl groups include tetraalkoxysilanes, hexaalkoxydisilanes, tetrakis(alkoxy,alkoxy)silanes and bis(trialkoxysilyl)alkanes. Especially preferred compounds having a reactive silyl group are monofunctional silanes, which are compounds with a single reactive silyl group. Suitable compounds with a single reactive silyl group include alkoxytrialkylsilanes, hydroxytrialkylsilanes and acyloxytrialkylsilanes. Alkoxytrialkylsilanes are particularly preferred. Particularly preferred compounds having a reactive silyl group include ethoxytrimethylsilane, glycidoxypropyltrimethoxysilane (GLYMO) and methyltrimethoxysilane. In some embodiments, the compositions include more than one compound having a reactive silyl group. For example, the composition may include a first compound having a reactive silyl group and a second compound having a reactive silyl group. For the avoidance of doubt, silicon-containing compounds that do not include reactive silyl groups, such as polymeric silicon-containing species including polysiloxanes (also known as silicones), which include polymeric chains of —Si(R)₂—O— units where R is alkyl or aryl, are not compounds having a reactive silyl group of the present invention.

Advantageously, the composition comprises one or more compounds having a reactive silyl group in an amount of at least 8% by weight, preferably, at least 10% by weight. More preferably, the composition comprises at least 25% by weight of compounds having a reactive silyl group and especially at least 30% by weight of compounds having a reactive silyl group. The composition optionally comprises more than 30% by weight of compounds having a reactive silyl group, for example, at least 32% by weight of compounds having a reactive silyl group. In some embodiments, the composition comprises at least 50% by weight of compounds having a reactive silyl group. Compositions having high levels of compounds having a reactive silyl group, for examples amounts of at least 25% by weight and in particular more than 30% by weight, have been found to provide cured images that dissolve cleanly in alkaline solutions in some embodiments. The composition may, optionally, comprise compounds having a reactive silyl group in an amount of no more than 90% by weight. The reactive silyl group may cure by cross-linking with other reactive silyl groups, other acid-curable reactive groups present in the compounds having a reactive silyl group or by cross-linking with acid-curable reactive groups in any optional polymerisable monomers that do not include reactive silyl groups which may be present in the composition.

The radiation-curable compositions are advantageously cured or partially cured in step (b) using electron beam or actinic radiation. Preferably, the composition is fixed onto the substrate in an initial curing step on exposure to electron beam or actinic radiation. The actinic radiation used in step (b) is preferably light, for example UV light. On exposure to radiation, reactions that polymerise and/or cross-link constituents of the radiation-curable composition are initiated. The composition may, optionally, include a photoinitiator that is activated on exposure to actinic radiation, such as light and in particular UV light. The composition may, alternatively, be cured on exposure to electron beam radiation that initiates curing without requiring the presence of a photoinitiator.

The curing of the printed composition in step (b) may, optionally, also include the step of heating the printed composition. A thermal curing step preferably hardens or further cures the masking composition following an initial fixing step. The step of heating the printed composition may, optionally, include heating to a temperature of at least 80° C., for example, to a temperature of at least 100° C. In some embodiments, the step of heating the printed composition includes heating to a temperature of at least 150° C. Advantageously, the printed composition is heated to a temperature of at least 80° C., preferably at least 100° C. and in some embodiments at least 150° C., for at least 10 minutes, for example, to a temperature of at least 80° C., preferably at least 100° C. and in some embodiments at least 150° C., for at least 15 minutes. The printed composition may, optionally, be heated to a temperature of at least 80° C., preferably at least 100° C. and in some embodiments at least 150° C., for at least 30 minutes.

The cured image is advantageously acid-resistant. An acidic solution is a solution, preferably an aqueous solution, having a pH below 7.0. The cured image is advantageously not released from the substrate on treatment with, for example immersion in or rinsing with, an acidic solution. Thus, a cured image that has adhered to a substrate does not dissolve, peel off or flake off or otherwise become detached from the substrate on treatment with an acidic solution for at least 1 minute. Advantageously, the cured image remains adhered to the substrate on treatment with an acidic solution of pH 4.0 for at least 1 minute, preferably at least 10 minutes, more preferably at least 1 hour. Preferably, the cured image remains adhered to the substrate on treatment with an acidic solution of pH 3.0 for at least 1 minute, preferably at least 10 minutes, more preferably at least 1 hour. More preferably the cured image remains adhered to the substrate on treatment with an acidic solution of pH 2.5 for at least 1 minute, preferably at least 10 minutes, more preferably at least 1 hour. Even more preferably, the cured image remains adhered to the substrate on treatment with an acidic solution of pH 2.0 for at least 1 minute, preferably at least 10 minutes, more preferably at least 1 hour. In one embodiment, the cured image remains adhered to the substrate on treatment with an acidic solution of pH 1.5 for at least 1 minute, preferably at least 10 minutes, more preferably at least 1 hour. In a further embodiment, the cured image remains adhered to the substrate on treatment with an acidic solution of pH 1.0 for at least 1 minute, preferably at least 10 minutes, more preferably at least 1 hour. In a yet further embodiment the cured image remains adhered to the substrate on treatment with an acidic solution of pH −1.0 for at least 1 minute, preferably at least 10 minutes, more preferably at least 1 hour. For example, the cured image may remain adhered to the substrate on treatment with an acidic solution having a pH in the range of from 0.5 to 7 for at least 1 minute, preferably at least 10 minutes, more preferably at least 1 hour. The cured image may, for example, remain adhered to the substrate on immersion in a solution of 5% H₂SO₄ at 50° C. for at least 1 minute, preferably at least 10 minutes, more preferably at least 1 hour.

In one embodiment the cured image is resistant to acid, and the surface of the substrate is modified in step (c) by a process involving the use of an acidic solution. Advantageously, the surface of the substrate is modified in step (c) in a process involving the use of an acidic solution of pH 5.0 or below, preferably pH 4.0 or below, for example, pH 3.0 or below. In one embodiment the surface of the substrate is modified in step (c) in a process involving the use of an acid of pH 2.0 or below. In a further embodiment the surface of the substrate is modified in step (c) by a process involving the use of an acidic solution having a pH of 1.5 or below, for example pH 1.0 or below. Advantageously, the cured image remains adhered to the substrate under the conditions used in step (c). Preferably, the surface of the substrate is modified in step (c) by a process involving the use of an acidic solution having a pH of −0.5 or above, more preferably pH 0.5 or above and especially pH 1.0 or above. For example, the surface of the substrate may be modified in a process involving the use of an acidic solution having a pH in the range of from about 1 to about 6. Typically, the surface of the substrate is modified in a process involving the use of an acidic solution having a pH in the range of from about 2 to about 5.5, for example a pH in the range of from about 3 to about 5. The surface of the substrate may, optionally, be etched using acid in step (c).

In one embodiment the invention provides a method of producing an article including a pattern of conductive material on the surface comprising the steps of: ink jet printing a radiation-curable, masking composition, comprising a compound having a reactive silyl group and which cures to form an alkali-removable image, onto the surface of the article; exposing the printed composition to radiation to form a cured image; modifying the unmasked areas of the surface; and, optionally, treating the cured image with an alkaline solution to release the cured image from the article. Thus, the conductive layer remains present only on the masked areas of the surface. If and when the masking image is removed, the conductive layer on the previously masked areas of the substrate is exposed. For example, the substrate may include a copper layer that is etched from the surface of the substrate on treatment with acid. The composition may be ink jet printed onto selected regions of the copper surface of a circuit board or the like and cured to form an acid-resistant image. On treatment with acid, the unmasked areas of the copper surface of the board are etched thereby removing the copper layer. The masking composition may subsequently be removed using an alkaline solution, which does not adversely affect the copper surface of the board, thus revealing the previously masked regions of the surface. Accordingly, a circuit board may be produced with a layer of copper being present in selected regions of the surface.

In one embodiment, the cured image can advantageously withstand a temperature of at least 100° C. for at least 10 minutes, preferably at least 20 minutes, more preferably at least 30 minutes and especially at least 1 hour without significantly degrading. Preferably, the cured image can withstand a temperature of at least 150° C. for at least 10 minutes, preferably at least 20 minutes, more preferably at least 30 minutes and especially at least 1 hour without significantly degrading and, more preferably, the cured image can withstand a temperature of at least 200° C. for at least 10 minutes, preferably at least 20 minutes, more preferably at least 30 minutes and especially at least 1 hour without significantly degrading. In one embodiment, the cured image can withstand a temperature of at least 250° C. for at least 10 minutes, preferably at least 20 minutes, more preferably at least 30 minutes and especially at least 1 hour without significantly degrading, for example, the cured image can withstand a temperature of at least 300° C. for at least 10 minutes, preferably at least 20 minutes, more preferably at least 30 minutes and especially at least 1 hour without significantly degrading. In a further embodiment the cured image can withstand a temperature of at least 350° C. for at least 10 minutes, preferably at least 20 minutes, more preferably at least 30 minutes and especially at least 1 hour without significantly degrading, for example a temperature of at least 400° C. for at least 10 minutes, preferably at least 20 minutes, more preferably at least 30 minutes and especially at least 1 hour without significantly degrading.

The substrate may, optionally, be modified in step (c) by a process involving the exposure of the substrate to an elevated temperature, for example, a temperature of 100° C. or higher. Preferably, the substrate is modified in step (c) by a process involving the exposure of the substrate to a temperature of 150° C. or higher. In one embodiment the substrate is modified in step (c) by a process involving the exposure of the substrate to a temperature of 200° C. or higher, for example a temperature of 250° C. or higher. In a further embodiment, the substrate is modified in step (c) by a process involving the exposure of the substrate to a temperature of 300° C. or higher, for example a temperature of 350° C. or higher. The substrate may, for example, be modified using a plasma vapour deposition process. A conductive layer may, optionally, be deposited onto the substrate using a plasma deposition process. In one embodiment, a masking composition is ink jet printed onto regions of the surface of a substrate; the masking composition is cured; a conductive layer is applied to the masked and unmasked regions of the surface of the substrate; and the mask is removed thus exposing areas of the substrate that do not have the applied conductive layer.

In one embodiment the invention provides a method of producing an article including a pattern of conductive material on the surface comprising one or more of the steps of: ink jet printing a radiation-curable masking composition comprising a compound having a reactive silyl group, which cures to form an alkali-removable image, onto the surface of the article; exposing the printed composition to radiation to form a cured image; depositing a conductive layer onto the surface of the article; and, optionally, treating the cured image with an alkaline solution to release the cured image from the substrate. If and when the masking image is removed, areas of the substrate that do not have the applied conductive layer are exposed, the conductive layer only being present on the previously unmasked areas of the surface. The conductive layer may adhere to the masked regions and be removed from those regions of the surface together with the mask. Alternatively, the conductive layer does not adhere to the masked areas of the surface and thus be selectively deposited on the unmasked regions.

In one embodiment the substrate is a non-porous substrate, for example glass or silicon or a polymer such as polyimide. The substrate is, for example a laminated material such as an epoxy laminate. In one embodiment, the substrate has a metallic or other conductive surface. For example, the substrate may be a metal surface such as a copper layer. In another embodiment, the substrate is a circuit board. Circuit boards are typically made of laminated materials such as epoxy laminates. In one embodiment the substrate is a photovoltaic board. Photovoltaic boards typically comprise a silicon surface. Compositions of the invention are preferably formulated to adhere well to such substrates. Compositions of the invention may, optionally, be formulated to adhere well to metallic or other conductive surfaces. For example, compositions of the invention may be formulated to adhere well to metal surfaces, such as copper.

The cured image is released from a substrate to which it has adhered on treatment with an alkaline solution. Advantageously, the cured image dissolves or flakes off the substrate on treatment with the alkaline solution. Preferably, the cured image dissolves in alkaline solution. In some embodiments the cured masking compositions become detached to the substrate when treated with alkaline solution by flaking off in small pieces, for example, pieces with a maximum dimension of less than 10 mm and preferably less than 5 mm. It is advantageous for the cured mask to be dissolved in the washing solution or be removed in small pieces which may remain in suspension, thereby reducing the need filter the washing solution to remove large pieces of the cured masking composition. The term “flakes” will be understood be the person skilled in the art and is commonly used in the printed circuit board industry to refer to the manner in which a mask becomes detached from a substrate in small pieces. The term “peeling” is also commonly used in the art to describe how a composition becomes detached as a sheet, for example, as a filmy sheet.

An alkaline solution is a solution, preferably an aqueous solution, having a pH above 7.0. The cured image may, for example, be released from the substrate on treatment with an alkaline solution of pH 7.5 or above within 30 minutes, preferably within 20 minutes, more preferably within 10 minutes and especially within 5 minutes. In one embodiment, the cured image is released from the substrate on treatment with an alkaline solution of pH 9.0 or above within 30 minutes, preferably within 20 minutes, more preferably within 10 minutes and especially within 5 minutes, for example, pH 10.0 or above within 30 minutes, preferably within 20 minutes, more preferably within 10 minutes and especially within 5 minutes. In a further embodiment, the cured image is released from the substrate on treatment with an alkaline solution of pH 11.0 or above within 30 minutes, preferably within 20 minutes, more preferably within 10 minutes and especially within 5 minutes. In a yet further embodiment, the cured image is released from the substrate on treatment with an alkaline solution of pH 12.0 or above within 30 minutes, preferably within 20 minutes, more preferably within 10 minutes and especially within 5 minutes. The substrate is treated with an alkaline solution of above pH 7.0 or above in step (d), for example an alkaline solution of pH 7.5 or above. The substrate may, for example, be treated with an alkaline solution of pH 9.0 or above. In one embodiment, the substrate is treated with an alkaline solution of pH 10.0 or above. In a further example, the substrate is treated with an alkaline solution of pH 11.0 or above. In yet a further embodiment, the substrate is treated with an alkaline solution of pH 12.0 or above. Advantageously, the substrate is treated with an alkaline solution of pH 14.0 or below. In one embodiment, the substrate is treated with an alkaline solution of pH 13.0 or below. In a further embodiment, the substrate is treated with an alkaline solution of pH 12.0 or below. It has been found that the use of very strongly alkaline solutions to remove the cured masking image may have a detrimental effect on some substrates. Advantageously, the masking composition is such that it cures to form an image that is released on treatment with alkaline solution of a modest or low alkalinity, for example a pH of below 14, preferably a pH of below 13 and more preferably a pH of below 12, such compositions being suitable for use as a mask in a wide range of applications and on a wide range of substrates. Preferably, the cured film is released from the substrate on treatment with an alkaline solution having a pH of from 7 to 14, especially a pH of from 8.5 to 13, within 20 minutes. The cured image is preferably released from the surface of the substrate by treatment with 5% by weight solution of KOH in water at 50° C. within 30 minutes, preferably within 20 minutes, more preferably within 10 minutes and especially within 5 minutes. The cured image is advantageously released from the substrate on washing with or immersion in an alkaline solution. Preferably, the cured image is released on immersion in alkaline solution, for example, immersion for 20 minutes or less. Agitation of a solution may, optionally, aid release of a cured image on immersion. Preferably, no mechanical assistance, such as scraping of the surface of the image, is required to release the cured image on treatment with alkaline solution. Preferably, the cured image is released from the substrate solely by the action of the alkaline solution, for example on rinsing of the substrate with an alkaline solution.

In addition to the reactive silyl groups, reactive groups present in compounds of the composition optionally include polymerisable groups that are not a reactive silyl groups. The compound comprising the reactive silyl group may, optionally, include a polymerisable group that is not a reactive silyl group. The composition may, optionally, further comprise a polymerisable monomer does not include a reactive silyl group and that includes a polymerisable group. The polymerisable groups that are not reactive silyl groups include those which are polymerised by a cationic or free radical mechanism.

Polymerisable groups that are not reactive silyl groups and that can be polymerised by a cationic polymerisation mechanism include acid-curable cyclic ester, cyclic carbonate, oxetane and epoxide functional groups. A preferred polymerisable group that may be present in the composition is an epoxide functional group and the composition optionally includes one or more compounds having such groups. The presence of acid-curable groups other than reactive silyl groups in the compositions of the invention may assist in enabling cross-linking between the components of the composition thus providing a cured film of an acceptable hardness and chemical resistance.

Polymerisable groups, which may be present in compounds of the composition, that are not reactive silyl groups and that can be polymerised by a free radical mechanism include ethylenically unsaturated groups, such as acrylates. The presence of compounds having free radical-curable polymerisable groups in the composition may bring some of the desirable properties of free radical-curable inks to the masking compositions of the invention. Embodiments of the invention that include a compound comprising a reactive silyl group and also a compound comprising a free radical-curable polymerisable group in the compositions may advantageously benefit from the ease of use of a free radical-curable composition including their good pot-life as well as the superior adhesion to substrates, hardness and chemical resistance provided by acid-curable compositions. Furthermore, compounds comprising free radical-curable polymerisable groups that are present in the composition may advantageously be cured in a separate step to the step which cures acid-curable groups of the composition. For example, the free radical-curable polymerisable groups may be cured in an initial step to fix the printed composition to the substrate and the acid-curable groups may be cured in a subsequent step that hardens the composition thereby forming a mask.

In one embodiment, the invention provides a radiation-curable, composition comprising a component having a reactive silyl group and a polymerisable monomer that does not include a reactive silyl group. For example, the composition may comprise at least 5% by weight of the total composition of one or more polymerisable monomers which do not include a reactive silyl group. Preferably, the composition may comprise at least 10% by weight of the total composition of one or more polymerisable monomers which do not include a reactive silyl group. In some embodiments, the composition may comprise at least 20% by weight of the total composition of one or more polymerisable monomers which do not include a reactive silyl group. The presence of polymerisable monomers in addition to the component having the reactive silyl group has been found to enable compositions with a variety of different properties to be formulated that are suitable for a range of masking applications. The polymerisable monomer that does not include a reactive silyl group is, preferably, a free radical-curable monomer or a cationically-curable monomer.

In some embodiments the ink jet printable-composition includes a component having a reactive silyl group and a free radical-curable monomer that does not include a reactive silyl group. The free radically-curable monomer that does not include a reactive silyl group is, for example, an ethylenically unsaturated monomer selected from the group consisting of acrylate monomers, methacrylate monomers, vinyl monomers, such as, N-vinyl caprolactam or N-vinyl pyrrolidone, and styrenes. Preferably, the free radically-curable monomer that does not include a reactive silyl group is selected from the group consisting of acrylates and methacrylates. An example of a suitable free radical-curable monomer that does not include a reactive silyl group is CTFA (cyclic trimethylolpropane formal acrylate). In some embodiments, the ink jet printable compositions comprise significant levels of free radically-curable monomers that do not include a reactive silyl group and also significant levels of compounds having a reactive silyl group. For example, the inks may, optionally, include free radically-curable monomers that do not include a reactive silyl group in an amount of at least 30% by weight and also compounds having a reactive silyl group in an amount of at least 10% by weight. Preferably, free radically-curable monomers that do not include a reactive silyl group and compounds having a reactive silyl group together make up at least 60% by weight of the total composition and more preferably, make up at least 70% by weight of the total composition. In one embodiment, the composition is substantially free of components that are polymerisable by a cationic mechanism that do not include a reactive silyl group.

The composition optionally further comprises a free radical photoinitiator. The free radical photoinitiator is a compound that generates free radicals on exposure to actinic radiation, and in particular UV light, to initiate a free radical curing reaction. Advantageously, the free radical photoinitiator is present in an amount greater than 0.001% by weight based on the total weight of the composition, preferably in an amount greater than 0.01% by weight based on the total weight of the composition and more preferably in an amount greater than 0.1% by weight based on the total weight of the composition. Advantageously, the free radical-photoinitiator is present in an amount less than 10% by weight, preferably less than 5% by weight, based on the total weight of the composition. Suitable free-radical photoinitiators will be known to the skilled person. Alternatively, free radical-curable groups present in the composition is cured using electron beam radiation. In some embodiments, the compositions of the invention are substantially free of free radical photoinitiators.

In some embodiments, the composition includes a component having a reactive silyl group and a cationically-curable monomer that does not include a reactive silyl group. The presence of cationically-curable polymerisable monomers in addition to the component having a reactive silyl group has been found to enable compositions to be formulated with a range of desirable properties. Preferably, the cationically-curable monomer that does not include a reactive silyl group includes an epoxide functional group. Acid-curable groups in the cationically-curable curable monomer that does not include a reactive silyl group may cross-link with reactive silyl groups in the component having a reactive silyl group. Suitable cationically-curable monomers that do not include a reactive silyl group include dioxetane, oxetane, propylene carbonate, butyrolactone, caprolactone and cycloaliphatic epoxide resins such as 3,4-epoxycyclohexylmethyl-3,4-epoxycyclohexane carboxylate (Cyracure™ UVR-6105) and bis(3,4-epoxycyclohexyl)adipate (Cyracure™ UVR-6128).

Cationically-curable monomers that are polymerisable by a cationic mechanism that do not include a reactive silyl group may be included in addition to components that are curable by a free radical mechanism and the compounds that include a reactive silyl group in a hybrid cationic/free radical composition. Alternatively, the compositions may comprise components that are polymerisable by a cationic mechanism that do not include a reactive silyl group and compounds that include a reactive silyl group in a cationic composition that is substantially free of free radical-curable monomers.

Advantageously, the compound having a reactive silyl group polymerises under the conditions of the invention thus assisting in the curing of the composition. For example, compounds that include more than one reactive silyl group may polymerise. The component having a reactive silyl group may, for example, be of the formula X—Si(—OR)₃, wherein X and R are independently C₁₋₄ alkyl. A preferred component having a reactive silyl group is methyltrimethoxysilane. Preferably, the composition comprises compounds having a reactive silyl group that include a further acid-curable reactive group such as an epoxide, oxetane or carbonate functional group in addition to the reactive silyl group. The compound having a reactive silyl group may, for example, be an epoxy-terminated silane. The compounds having a reactive silyl group may, optionally, include two or more reactive silyl groups and also one or more further acid-curable reactive groups. For example, suitable compounds having a reactive silyl group are glycidyloxyalkyltrialkoxysilanes, such as 3-glycidyloxypropyltrimethoxysilane (GLYMO), which includes an acid curable oxirane functional group and three reactive alkoxysilyl groups. The inclusion of significant amounts of GLYMO in embodiments of the compositions, for example in an amount of at least 15% by weight, has been found to be particularly desirable. Embodiments including high levels of GLYMO, have been found to provide a cured film that dissolves in an alkaline solution.

The compound having a reactive silyl group may, optionally, have a single reactive silyl group. The invention further provides a radiation-curable, composition suitable for use as a mask, comprising a compound having a single reactive silyl group. It has been found that the presence of a compound having a single reactive silyl group is particularly advantageous in some embodiments of the invention. The component having a reactive silyl group may, optionally, have a single reactive silyl group as the sole acid-curable group. The component having the reactive silyl group may, optionally, be an alkoxytrialkylsilane. For example, the component having a single reactive silyl group may be a silane of the formula R¹O—Si(—R²)₃, wherein R¹ and R² are independently C₁₋₄ alkyl, such as ethoxytrimethylsilane. The compound having a single reactive silyl group may, optionally, include a further acid-curable reactive group in addition to a single reactive silyl group.

Preferably, compositions comprising a compound having a single reactive silyl group as the further comprise a second compound having more than one reactive silyl groups. For example, the composition may comprise a first compound that has a single reactive silyl group, such as ethoxytrimethylsilane, and a second compound that includes more than one reactive silyl group such as methyltrimethoxysilane. Preferably, the second compound that includes a more than one reactive silyl group also comprises a further acid-curable functional group. For example, the second compound that includes more than one reactive silyl group and a further acid-curable group may be GLYMO.

The ink-jet printable composition may, optionally, comprise a cationic photoinitiator. The presence of a cationic photoinitiator may be advantageous in promoting the curing or partial curing of acid-curable components on exposure of the composition to actinic radiation. Attentively or additionally the cationically-curable components are cured or cured further by exposure of the printed composition to heat.

It has further been found that the presence of a cationic photoinitiator or other acid-generating catalyst is not essential to enable the composition to be cured in some embodiments of the invention. For example, in embodiments in which free radical-curable polymerisable groups are present, the composition may be substantially free of acid-generating catalysts. In such embodiments, acid-curable groups including the reactive silyl groups may be cured by heating the printed composition. Optionally, the composition comprises acid-generating catalysts in an amount of less than 0.2 by weight of the total composition, for example, less than 0.1% by weight of the total composition. The composition optionally comprises acid-generating catalysts in an amount of less than 0.02% by weight of the total composition. Advantageously, the composition is substantially free of an acid-generating catalyst. Preferably, the composition is substantially free of iodonium acid-generating catalysts. It has been found that the presence of acid-generating catalyst in quantities sufficient to effect the curing of the composition may also reduce than the pot-life of an ink jet printable composition. The presence of iodonium acid-generating catalyst has been found to have a particularly detrimental effect on the pot-life of the compositions. Optionally, the compositions of the invention are substantially free of photoinitiators. Embodiments of the printable compositions of the invention, which do not include an acid-generating catalyst, have been found to have a good pot-life and so may be particularly suitable for use in ink jet printing process. The term “pot-life” used herein refers to the length of time that a composition may be stored prior to use, for example, in suitable container or “pot” and in particular the time a composition may be stored in printing equipment without degrading to an extent that significantly impairs print quality or adversely affects the printing equipment. Preferably, the composition has a pot life of at least 1 week and, more preferably, a pot-life of at least 3 months and most preferably of at least 6 months.

Advantageously, the composition contains an acidic component. An acidic component is a compound including an acidic functional group such as a carboxylic group, a phenolic group or a sulphate group. Preferably, the acidic component is a polymerisable monomer. The acidic component may, optionally, have an acid value within the range of from 50 to 300 mg KOH/g, for example, in the range of from 100 to 220 mg KOH/g. Suitable acidic components include monofunctional acid esters such as Sartomer 9050 that has an acid value of 130-195 mg KOH/g and trifunctional acid esters such as Sartomer 9051 that has an acid value of 120-180 mg KOH/g. The presence of an acidic component has been found to assist the curing of the cationic components in some embodiments. In some embodiments, the presence of an acidic component may increase the reactivity of the reactive silyl groups. The presence of an acidic component has been found to increase the level of cross-linking between compounds containing reactive silyl groups and other components of the composition. Advantageously, the composition comprises acidic components in an amount of at least 1% by weight, preferably at least 2% by weight, more preferably at least 5% by weight and especially at least 8% by weight. Advantageously, the composition comprises acidic components in an amount of no more than 20% by weight of the total composition and preferably no more than 15% of the total composition. High levels of acidic components (for example, amounts in excess of 20% by weight of the total composition) have been found to decrease the pot-life of the compositions in some embodiments.

Advantageously, the viscosity of the composition is suitable for use in ink jet printing. Preferably, the viscosity is less than 50 mPas at 25° C. and preferably less than 35 mPas at 25° C.

The composition may, optionally, further comprise an aldehyde resin. Preferably the composition comprises an aldehyde resin at an amount of at least 5 wt % and more preferably in an amount of at least 10 wt % based on the total weight of the composition. Preferably, the aldehyde resin is a novolac resin. A novolac resin is a thermoplastic phenol-formaldehyde resin made with an excess of phenol and is commonly used in the formulation of varnishes. It has been found that inclusion of an aldehyde resin and in particular a novolac resin may enhance the performance of the ink in acid etching applications in some embodiments. For example, the inclusion of an aldehyde resin in the composition may enhance the acid resistance of the cured film. In some embodiments, the inclusion of an aldehyde resin in the composition may result in a cured film being removed more cleanly in an alkaline solution.

Suitable optional additives which may be used in conjunction with the principal components of the ink formulations of the present invention include stabilizers, plasticizers, waxes, slip aids, levelling aids, adhesion promoters, surfactants and fillers, for example as described in “The Printing Ink Manual”, 5^{th} Edition, edited by R. H. Leach et al., published in 1993 by Blueprint. Preferably, the composition comprises a surfactant and/or a stabilizer. Preferably the stabilizer is an antioxidant. The presence of an antioxidant in the compositions comprising free radical-curable monomers may enhance the stability of the composition. The presence of a surfactant has been found to be particularly advantageous in cationically-curable ink compositions of the invention.

The method of the present invention has been found to be particularly suited to the production articles in which a thin layer of conductive material is required on the surface. Such articles are used, for example, in the production of electronic circuit boards and photovoltaic cells.

The invention will now be further described for the purposes of illustration only with reference to the specific embodiments given in Example A to C.
Epoxide 6128 is bis(3,4-epoxycyclohexyl)adipate, a cationically curable epoxide monomer that is available from the Dow Chemical Corporation of Michigan, USA under the trade name Cyracure™ UVR-6128.
Epoxide 6105 is 3,4-epoxycyclohexylmethyl-3,4-epoxycyclohexane carboxylate, a cationically curable epoxide monomer that is available from Dow Chemical Corporation of Michigan, USA under the trade name Cyracure™ WR-6105.
IGM (Omnicat) BL550 is a cationic photoinitiator that is available from IGM resins of Waalwljk, the Netherlands.
ITX is isopropylthioaxanthone, a free radical photoinitiator that is available from the Abermarle Corporation of Louisiana, USA under the trade name Firstcure™ ITX.
Irgastab UV-10 is a nitroxyl-based stabiliser that is available from Ciba Speciality Chemicals.
GLYMO is glycidoxypropyltrimethoxysilane.
Sartomer 9050 is a monofunctional acid ester comprising methacrylate acid ester and 2-(2-ethoxyethoxy)ethyl acrylate that is available from the Sartomer Corporation of Pennsylvania, USA.
Sartomer 9051 is a trifunctional acid ester comprising methacrylate acid ester and ethoxylated trimethylolpropane triacrylate esters that is available from the Sartomer Corporation of Pennsylvania, USA.
EtMS is ethoxytrimethylsilane
CTFA is cyclic trimethylolpropane formal acrylate
TPO is 2,4,6-Trimethylbenzoylphenyl phosphineoxide that is available from Ciba Speciality Chemicals under the trade name Darocur™ TPO.
Irgacure 184 is 1-hydroxy-cyclohexyl-phenyl ketone that is available from Ciba Speciality Chemicals.
Ethanox 703 is 2,6-di-tertiarybutyl-N,N-dimethylamino-p-cresol, an antioxidant that is available from the Abermarle Corporation of Louisiana, USA.
TMPO is trimethylolpropane oxetane.
Tegoglide 435 is a polyalkoxy-polysiloxane surfactant available from the Goldschmidt Chemical Co. of Hopewell, Va., USA.
Alvanol PN 320 is a phenol formaldehyde Novolac resin that is available from Vianova Resins of Montreal, Canada.

### Example A

### Cationic Compositions

Components and Viscosity of Cationic Compositions

Table 1 shows the composition and viscosity of four cationically-curable masking compositions of the invention. The composition of Comparative Example 1 does not include a compound having a reactive silyl group and thus is outside the scope of the present invention.

TABLE 1

| | Example Number | | | | |
|---|---|---|---|---|---|
| | Example 1 | Example 2 | Example 3 | Example 4 | Comparative 1 |
| Code | 1-61-1 | 1-61-2 | 1-61-3 | 1-61-4 | 1-61-5 |
| Description | 10% GLYMO | 20% | 30% GLYMO | high | 0% GLYMO |
| | | GLYMO | | MTMS/GLYMO | |
| Epoxide 6105 (+6% from pi) | 24.0 | 24.0 | 24.0 | 0 | 24.0 |
| Bis(1-ethyl(3-oxetanyl))methyl | 46.9 | 36.9 | 26.9 | 0 | 56.9 |
| ether | | | | | |
| Propylene carbonate (+3% | 7.0 | 7.0 | 7.0 | 11.0 | 7.0 |
| fromPI) | | | | | |
| GLYMO | 10.0 | 20.0 | 30.0 | 21.0 | 0 |
| MTMS | 0 | 0 | 0 | 55.9 | 0 |
| IGM BL 550 | 12.0 | 12.0 | 12.0 | 12.0 | 12.0 |
| Tegoglide 435 | 0.1 | 0.1 | 0.1 | 0.1 | 0.1 |
| Total | 100.0 | 100.0 | 100.0 | 100.0 | 100.0 |
| Initial Visc 50° C. | 7.75 | 6.72 | 6.30 | 1.9 @25 C. | 10.10 |
| Visc after 10 weeks storage @ | 10.5 | 7.7 | 6.93 | 1.7 | 10 |
| 30° C. | | | | | |

Thermo Gravimetric Analysis (TGA) Data of Cationic Compositions

The masking compositions of Table 1 were applied to a glass microcope slide, previously cleaned by wiping with IPA (isoproplyl alcohol) as a 12 μm wet film of ink using a K-bar. The composition was cured using UV radiation from an Fe doped

Hg lamp. The cured films were tested for thermal stability by TGA analysis. The mean decomposition onset temperatures are shown in Table 2:

TABLE 2

| | | Decomposition |
|---|---|---|
| Example | Sample code | onset (° C.) |
| 1 | 1-61-1 | 234.46 |
| 2 | 1-61-2 | 236.54 |
| 3 | 1-61-3 | 263.10 |
| 4 | 1-61-4 | 297.59 |
| Comp 1 | 1-61-5 | 236.80 |

The composition of Example 3 that includes a high level of GLYMO (30 wt %) had an improved thermal resistance compared to compositions with no or lower levels of compounds having reactive silyl groups. Example 4 that includes 63 wt % methyl trimethoxy silane, a composition having three reactive silyl groups, together with 21 wt % GLYMO displayed the best thermal resistance.

Alkali Stripping Performance of Cationic Formulations

Table 3 shows the composition and viscosity of Examples 5 to 8 and Comparative Example 2 that does not include a compound having a reactive silyl group.

TABLE 3

| | Example Number | | | | |
|---|---|---|---|---|---|
| | Comp arative 2 | Example 5 | Example 6 | Example 7 | Example 8 |
| Description | Silane-free | 10% GLYMO | High MTMS | Dye | Clear |
| | | | & GLYMO | | |
| Code | 1-53-5 | 1-53-1 | 1-53-4 | 1-18-1 | 1-18-3 |
| 6105 Epoxide | 27.24 | 27.24 | 0 | 0 | 0 |
| 6128 Epoxide | 0 | 0 | 0 | 22.7 | 23.5 |
| Trimethylolpropane | 0 | 0 | 0 | 5.68 | 5.88 |
| oxetane | | | | | |
| Bis(1-ethyl(3- | 38.66 | 28.66 | 0 | 0 | 0 |
| oxetanyl))methyl ether | | | | | |
| Butyrolactone | 0 | 0 | 0 | 2.27 | 2.35 |
| Propylene carbonate | 10 | 10 | 10 | 18.16 | 18.8 |
| GLYMO | 0 | 10 | 17.5 | 34.05 | 35.25 |
| MTMS | 0 | 0 | 52.4 | 0 | 0 |
| BL550 | 12 | 12 | 10 | 13.62 | 14.1 |
| Tegoglide 435 | 0.1 | 0.1 | 0.1 | 0.11 | 0.12 |
| Cyan dye | 0 | 0 | 0 | 3.41 | 0 |
| Cyan pigment dispersion | 12 | 12 | 10 | 0 | 0 |
| total | 100 | 100 | 100 | 100 | 100 |
| Viscosity @ 50° C. | 8.5 cPs | 12.2 cPs | 2 cPs @ | 13 | 13 |
| | | | 25° C. | | |
| Surface tension | 28.5 | 27 | 25 | 25.5 | 25.5 |
| Acid test | Excellent | Excellent | Excellent | Excellent | Excellent |
| Alkali test | Peeled | Peeled | dissolved | dissolved | dissolved |

The compositions of Table 3 were applied to a glass microscope slide, previously cleaned by wiping with IPA (isopropyl alcohol), as a 12 μm wet film of ink using a K-bar. The composition was cured using UV radiation from an Fe doped Hg lamp. The slides were placed in a 60° C. acid bath made up using H₂O 770 ml; CuCl₂ 216 g; HCl 200 ml; and H₂O₂ 30 ml for 5 minutes. No or minimal degredation in the cured film was observed. The slides were then placed in an alkali bath comprising a 5% KOH solution in water at 45° C. The cured films of examples 6, 7 and 8 that include compounds having reactive silyl groups at levels of more than 30% by weight dissolved in the alkaline solution. The cured film of Example 5 that includes 10% by weight of GLYMO, a compound having a reactive silyl group, and also Comparative Example 2 that does not include a compound having a reactive silyl group peeled off the substrate.

Alkali Stripping Performance After Heating

On immersion of glass slides including a cured film of Example 7 in an alkali bath comprising a 5% KOH solution in water at 45° C., the cured film dissolved within 1 minute. When identical slides were heated in an oven to 150° C. for 30 minutes, cooled and then immersed in the alkali bath, the cured film dissolved within 1 to 3 minutes. When yet further identical slides were heated to 150° C. for 30 minutes and then immersed in the alkali bath, the cured film dissolved within 3 minutes.

Cationic Composition Including an Aldehyde Resin

The composition of Example 9 shown in Table 4 that includes aldehyde resin Alvanol PN320 Novolac resin was found to have good acid resistance properties and dissolves cleanly in an alkali bath in 2.5 minutes.

TABLE 4

| | |
|---|---|
| Epoxy 6105 | 10 |
| Propylene Carbonate | 6.2 |
| Glymo | 13.8 |
| Mtms | 44.1 |
| BL550 | 6.7 |
| Tego 435 | 0.1 |
| Alnovol PN320 | 16.9 |
| Cationic Cyan CPT | 2 |
| KL245 | 0.2 |
| Total | 100 |
| Viscosity 30° C. | 8.5 cPs |

### Example B

### Compositions Comprising Monofunctional Silanes

Components and Viscosity of Compositions Comprising Monofunctional Silanes

Table 5 shows the composition and viscosity of five masking compositions of the invention that include ethoxytrimethylsilane, a compound having a single reactive silyl group.

TABLE 5

| | Example Number | | | | | |
|---|---|---|---|---|---|---|
| | Comp. 3 | Ex 10 | Ex 11 | Ex 12 | Ex 13 | Ex 14 |
| Description | Free-rad | hybrid | | | 100% cationic | |
| | control | low EtmS | High | High | low etms | low etms |
| | | low acid | EtmS | EtmS | | |
| | | | no acid | low acid | | |
| Code | 1-85-1 | 2-85-3 | 2-85-4 | 2-85-7 | 1-57-5 | 1-57-10 |
| CTFA | 83 | 73.0 | 53 | 48 | 0 | 0 |
| TPO | 2.3 | 4.5 | 4.5 | 4.5 | 0 | 0 |
| Irgacure 184 | 4.5 | 2.3 | 2.3 | 2.3 | 0 | 0 |
| Ethanox 703 | 0.2 | 0.2 | 0.2 | 0.2 | 0 | 0 |
| Epoxide 6105 | 0 | 0 | 0 | 0 | 28.4 | 0 |
| Epoxide 6128 | 0 | 0 | 0 | 0 | 0 | 30 |
| Bis(1-ethyl(3-oxetanyl))methyl | 0 | 0 | 0 | 0 | 27.5 | 0 |
| ether | | | | | | |
| Trimethylolpropane oxetane | 0 | 0 | 0 | 0 | 0 | 10.9 |
| Propylene carbonate | 0 | 0 | 0 | 0 | 10 | 16 |
| Butyrolactone | 0 | 0 | 0 | 0 | 0 | 9 |
| EtMs | 0 | 5.0 | 30 | 30 | 10 | 10 |
| Omnicat BL550 | 0 | 0 | 0 | 0 | 12 | 12 |
| Tegoglide 435 | 0 | 0 | 0 | 0 | 0.1 | 0.1 |
| Sartomer 9051 | 0 | 5.0 | 0 | 5 | 0 | 0 |
| Cyan dispersion | 10 | 10.0 | 10.0 | 10.0 | 0 | 0 |
| Black dispersion | 0 | 0.0 | 0.0 | 0.0 | 12 | 12 |
| TOTAL | 100.0 | 100.0 | 100.0 | 100.0 | 100.0 | 100.0 |
| Initial viscosity 50° C. | 8.85 | 7.71 | 1.89 | 1.95 | 9.03 | 11.7 |
| 1 week visc 50° C. | 8.9 | 8.25 | 2.12 | 2.24 | 8.88 | 11.7 |
| 60° C. acid bath | pass | pass | pass | pass | pass | pass |
| 45° C. alkali | peels off | peels off | peels off | peels off | peel off | peel off |

Acid Resistance and Removal with Alkali

The acid resistance and alkali removal properties of masking compositions of Table 5 were tested in the same manner as the compositions in Example A. The hybrid compositions of Examples 10, 11 and 12 and the cationic compositions of Examples 13 and 14 showed an acceptable level of acid resistance.

### Example C

### Free Radical/Cationic Hybrid Compositions

Components and Viscosity of Hybrid Compositions

Table 6 shows the composition and viscosity of three masking compositions of the invention that include CTFA, a free radical-curable monomer in addition to GLYMO a cationically-curable monomer that includes three reactive silyl groups. The composition of Comparative Example 3 does not include a compound having a reactive silyl group and thus is outside the scope of the present invention.

TABLE 6

| | Example Number | | | |
|---|---|---|---|---|
| | Comparative 3 | Example 15 | Example 16 | Example 17 |
| Description | Free-radical | Low glymo | High glymo | High glymo |
| | control | low acid | no acid | low acid |
| Code | 1-85-1 | 1-85-3 | 1-85-4 | 1-85-6 |
| CTFA | 83 | 73.0 | 53 | 48 |
| TPO | 2.3 | 4.5 | 4.5 | 4.5 |
| Irgacure 184 | 4.5 | 2.3 | 2.3 | 2.3 |
| Ethanox 703 | 0.2 | 0.2 | 0.2 | 0.2 |
| Glymo | 0.0 | 5.0 | 30 | 30 |
| Sartomer 9051 | 0.0 | 5.0 | 0 | 5 |
| Cyan dispersion | 10 | 10.0 | 10.0 | 10.0 |
| TOTAL | 100 | 100 | 100 | 100 |
| Initial viscosity 50° C. | 8.85 | 10.4 | 5.88 | 7.86 |
| 1 week visc 50° C. | 8.9 | 12.9 | 8.82 | 8.88 |
| 60° C. acid bath | pass | pass | pass | pass |
| 45° C. alkali | peels off | peels off | peels off | peels off |

Acid Resistance and Removal with Alkali

The masking compositions of Table 6 were applied to a glass microscope slide, previously cleaned by wiping with IPA (isopropyl alcohol), as a 12 μm wet film of ink using a K-bar. The composition was cured using UV radiation from an Fe doped Hg lamp. The slides were placed in a 60° C. acid bath made up using H₂O 770 ml; CuCl₂ 216 g; HCl 200 ml; and H₂O₂ 30 ml for 5 minutes. No or minimal degredation in the cured film was observed. The slides were then placed in an alkali bath comprising a 5% KOH solution in water at 45° C., which led to the peeling off of the cured film.

Properties of Hybrid Compositions at Elevated Temperatures

The results of testing the scratch and adhesion properties of the hybrid compositions of Examples 16, 17 and 12 and also the free radical-curable composition of Comparative Example 3 and the cationically-curable composition of Example 13 are shown in Table 7:

TABLE 7

| | Example Number | | | | |
|---|---|---|---|---|---|
| | Comp 3 | Ex 16 | Ex 17 | Ex 12 | Ex 13 |
| Description | Free- | High | High | High | Low etms |
| | radical | glymo | glymo | EtmS | |
| | control | no acid | low acid | low acid | |
| Code | 1-85-1 | 1-85-4 | 1-85-6 | 2-85-7 | 1-57-5 |
| | 60 minutes @ 25° C. | | | | |
| Scratch | 1 | 4 | 1 | 1 | 1 |
| Adhesion | 1 | 5 | 5 | 4 | 4 |
| | 60 minutes @ 100° C. | | | | |
| Scratch | 1 | 1 | 3 | 1 | 1 |
| Adhesion | 2 | 4 | 5 | 5 | 5 |
| | 60 minutes @ 200° C. | | | | |
| Scratch | 1 | 1 | 3 | 1 | 1 |
| Adhesion | 0 | 5 | 5 | 5 | 2 |
| | 60 minutes @ 300° C. | | | | |
| Scratch | 3 | 1 | 1 | 1 | 1 |
| Adhesion | 4 | 5 | 5 | 5 | 0 |

The masking compositions of Table 6 were applied to a glass microscope slide, previously cleaned by wiping with IPA (isopropyl alcohol) as a 12 μm wet film of ink using a K-bar. The composition was cured using UV radiation from an Fe doped Hg lamp. The slides having the cured films were tested for scratch resistance (hardness) and adhesion after having been placed in an oven at various temperatures for 60 minutes. Scratch resistance was scored from 1 for a poor scratch resistance up to 4 for a good scratch resistance. Adhesion was scored from 0 for a poor adhesion up to 5 for a good adhesion.

1-26. (canceled)

27. A method of modifying the surface of a substrate comprising the steps of:
a) masking a portion of the surface of the substrate by ink jet printing a radiation-curable masking composition comprising a compound having a reactive acyloxysilyl or alkoxysilyl group, which cures to form an alkali-removable image, thereon;
b) exposing the printed composition on the substrate to radiation to form a cured image;
c) modifying the unmasked areas of the substrate; and
d) treating the cured image with an alkaline solution in order to remove the cured image from the substrate.

28. The method of claim 27, wherein the curing of the printed composition in (b) comprises the step of heating the printed composition.

29. The method of claim 27, wherein the substrate is modified in (c) by a process comprising treatment of the surface of the substrate with acid.

30. The method of claim 29, wherein the substrate is treated in (c) with an acidic solution having a pH of 5.0 or below and at which the cured image remains adhered to the substrate.

31. The method of claim 29, wherein the substrate is etched using acid in (c).

32. The method of claim 31, wherein a copper layer is etched from the surface of the substrate by treatment with the acid.

33. The method of claim 27, wherein the substrate is modified in (c) by a process comprising exposure of the substrate to an elevated temperature.

34. The method of claim 33, wherein the cured image of (b) withstands a temperature of at least 100° C. for at least 10 minutes without significantly degrading, and the substrate is modified in step (c) by a process involving the use of temperature of 100° C. or higher.

35. The method of claim 33, wherein the substrate is modified in (c) by exposure to a plasma vapor deposition.

36. The method of claim 35 wherein a conductive layer is deposited onto the substrate.

37. A radiation-curable, ink-jet printable composition, comprising a compound having a reactive silyl group of the formula X—Si(—OR)₃, wherein X and R are independently C₁₋₄ alkyl and a polymerizable monomer that does not include a reactive silyl group.

38. The composition of claim 37 comprising at least 10% by weight of polymerisable monomer(s) that do not include a reactive silyl group.

39. The composition of claim 37, wherein the polymerizable monomer that does not include a reactive silyl group is a free radical-curable monomer and the composition optionally further comprises a free radical photoinitiator.

40. The composition of claim 38, wherein the polymerizable monomer that does not include a reactive silyl group is a cationically-curable monomer comprising an acid-curable functional group that is not a reactive silyl group.

41. The composition of claim 38, comprising a further compound which has a reactive acyloxysilyl or alkoxysilyl group.

42. The composition of claim 41, wherein the further compound comprising a reactive silyl group is of the formula X—Si(—OR)₃, wherein X and R are independently C₁₋₄ alkyl.

43. A radiation-curable, ink jet printable composition, comprising a compound having a single reactive acyloxysilyl or alkoxysilyl group.

44. The composition of claim 43, wherein the compound having a single reactive silyl group is an alkyloxy silane of the formula R¹O—Si(—R²)₃, wherein R¹ and R² are independently C₁₋₄ alkyl.

45. The composition of claim 43, further comprising a polymerizable monomer that does not include a reactive silyl group.

46. The composition of claim 45 comprising at least 10% by weight of polymerisable monomer(s) that do not include a reactive silyl group.

47. The composition of claim 43, wherein the polymerizable monomer that does not include a reactive silyl group is a free radical-curable monomer and the composition optionally further comprises a free radical photoinitiator.

48. The composition of claim 43, wherein the polymerizable monomer that does not include a reactive silyl group is a cationically-curable monomer comprising an acid-curable functional group that is not a reactive silyl group.

49. The composition of claim 43, comprising a further compound which has a reactive acyloxysilyl or alkoxysilyl group.

50. The composition of claim 49, wherein the further compound comprising a reactive silyl group is of the formula X—Si(—OR)₃, wherein X and R are independently C₁₋₄ alkyl.

51. A radiation-curable, ink-jet printable composition, comprising a reactive compound having a reactive acyloxysilyl or alkoxysilyl group, a further reactive compound having a reactive acyloxysilyl or alkoxysilyl group and a polymerizable monomer that does not include a reactive silyl group.

52. The composition of claim 51, wherein the reactive compound having a reactive acyloxysilyl or alkoxysilyl group is a trialkoxysilane.

53. The composition of claim 51, comprising at least 10% by weight of polymerizable monomer that does not include a reactive silyl group.

54. The composition of claim 51, wherein the polymerizable monomer that does not include a reactive silyl group is a cationically-curable monomer comprising an acid-curable functional group that is not a reactive silyl group.

55. The composition of claim 51, wherein the further compound having a reactive silyl group has more than one reactive acyloxysilyl or alkoxysilyl group.

56. The composition of claim 51, wherein the further compound having a silyl group includes a acid-curable functional group that is not a reactive silyl group.

57. The composition of claim 56, wherein the acid-curable functional group that is not a reactive silyl group is an epoxide functional group.

58. The composition of claim 57, wherein the compound having the reactive silyl group and the further acid-curable functional group that is not a reactive silyl group are epoxy-terminated silanes.

59. The composition of claim 51, further comprising a cationic photoinitiator.

60. The composition of claim 51, comprising at least 10% by weight of the total composition of components having a reactive silyl group.

61. The composition of claim 51, comprising an aldehyde resin.
